(19) United States
(12) Patent Application Publication
(10) Pub. No.: US 2014/0207546 A1
(43) Pub. Date: Jul. 24, 2014

(54) METHOD AND SYSTEM FOR MERCHANT MANAGED MARKETING DISTRIBUTION

(71) Applicant: Ricardo Nanez, San Antonio, TX (US)

(72) Inventor: Ricardo Nanez, San Antonio, TX (US)

(21) Appl. No.: 13/745,596

(22) Filed: Jan. 18, 2013

(51) Int. Cl. G06Q 30/02

(52) U.S. Cl. CPC G06Q 30/0277
USPC 705/14.15; 705/14.72; 705/14.66; 705/14.58

(57) ABSTRACT

A system and related method are disclosed for a platform that allows merchants to register, and enter their data, at which point the system generates sales, vouchers, or similar items automatically or using merchant input. Publication, by web or mobile app, can be controlled with parameters including geographic limitations, and published by divisions and employees under security authorizations. According to some embodiments, customers may pay a deposit for a redeemable version, refundable upon redemption.

### TECHNICAL FIELD

This invention relates to the field of certificate, coupon, voucher, and savings promotion distribution, in various electronic, print, and other media, and more particularly to a method and system for management and distribution of these coupons, vouchers, discounts, and savings promotions by a merchant either directly or through an intermediary host.

### BACKGROUND ART

Coupons, vouchers, discounts, promotional promotions, savings promotions, and redeemable value-add cards are herein collectively referred to as Promotions, and are increasingly used by daily deal websites and merchants on their company websites. The daily deal sites are frequently composed of a website (with mobile applications), sales people that target merchants, and writers that compose the Promotions to be input regularly by the site administrator. This process is costly and time consuming for the promoter, requiring dedication of resources to solicit, create, approve, and input the Promotion for consumers to purchase through the promoter and escrow or accounting of funds and distributions relating to the Promotion. Due in part to the cumbersome process, advertising with this media is costly for the merchant, limiting the number of merchants that advertise, and reducing the number of merchants featured by the promoter. Merchants are also unable to present to consumers Promotions that are time-sensitive or limited and targeted because of the sales and administrative process involved with existent methods. Because the merchants advertising through currently existing methods are limited by the constraints of those sales and administrative methods, merchants are encouraged to maximize the number and/or perceived value of the Promotions sold. For instance, a “daily deals” Promotion may have a limited number of total deal slots per market, therefore creating pressure to maximize the Promotion's exposure at the expense of merchant profitability. As well, limitations upon the quantity of Promotions sold and when consumers tend to redeem them results in congestion at the merchant's business, sometimes creating a degraded consumer experience.

Merchants that display the Promotions on their company website are limited to the traffic that they create and drive to their website. If a consumer is going to make a simple purchase for an everyday item or activity, he or she may spend a lot of time searching various websites for the best value.

### SUMMARY OF THE EMBODIMENTS

An object of the present invention is to provide a method, system, and platform for merchants to deliver both common Promotions as well as limited, targeted, and/or timed Promotions. There is therefore a need for a method of providing merchants with an invention that removes the obstacles presented by traditional Promotions and for consumers to search and select where they will make a purchase. These obstacles may include, but are not limited to, a large sales and support staff, accounting and distribution delays, inventory control, and restriction on competing Promotions within the Promotion pool.

Disclosed herein is a method of controlling distribution of Promotions for a merchant using a network-connected server running a user-facing application. In its most basic embodiment, the method involves having a merchant enter information about itself on the application, which assembles a profile of the merchant and saves it to a persistent storage. The application generates Promotions based on criteria established by the application or optionally by the merchant and the merchant selects the Promotions it wants to make available. The selections are saved to the persistent storage, and then are published to consumers over the network.

An additional embodiment of the method involves generating the Promotions by keeping generic versions of them in a persistent storage, retrieving those generic versions from the persistent storage along with the merchant's profile, and combining them to form Promotions specific to the merchant from which the merchant can select its choice of Promotions to publish. In another embodiment, the merchant creates its own Promotions on the application. Publication is controlled further by another embodiment that involves allowing the merchant to set parameters that control how the Promotions are published. Another technique disclosed for controlling publication is the creation of consumer profiles in the application, which are saved to the persistent storage, and used to produce parameters controlling how Promotions are published to the consumers in the profiles. Yet another method embodiment involves getting the location of the consumer from the consumer's device, and publishing the Promotions to that consumer only if the consumer's location matches geographic limitations in the publication parameters. Still another embodiment permits the merchant to create profiles under the main profile for branches, divisions, managers and employees. An additional embodiment permits the merchant to set security levels allowing the subjects of those profiles to publish or create certain Promotions. Finally, one more embodiment involves publishing a list of Promotions that are not redeemable to the consumer, converting them to redeemable form upon the payment of an electronic deposit by the consumer, and refunding the deposit to the consumer upon redemption.

Also disclosed is a system for controlling distribution of Promotions to consumers. The system consists of a server connected by a network such as the internet to a consumer's computer, tablet or phone, and a merchant's computer, tablet, or phone. The server hosts a application that is made up of a Network Communication Component which sends and receives data including merchant profile information and Promotions, a Processing Component that puts together merchant profiles and generates Promotions for the merchant to select, and a Data Storage Component that stores data including profile information, Promotions, and merchant selections thereof to a persistent storage.

A further embodiment of that system involves configuring the Data Storage Component to retrieve Promotions in generic form from the persistent storage, and the Processing Component to combine them with merchant profile information to produce merchant-specific Promotions. Another embodiment involves configuring the merchant's computer, tablet or phone to accept the merchant's creation of its own Promotions, and the configuration of the Network Communication Component to ask the merchant for that information and to receive it over the network, and the configuration of the Processing Component to create the Promotions the merchant requested using that information. According to another embodiment, the consumer's computer, tablet, or phone has a mobile application that interacts with the server. Still another embodiment involves the setting up the merchant client terminal to accept publication parameters, which the Network Communication Component is configured to receive, and the Processing Component is configured to use to prevent publication of Promotions to which those parameters pertain, except within those parameters. A further embodiment accepts consumer profile information at the computer, tablet, or phone of either the consumer or the merchant, which is received over the network by the Network Communication Component, saved by the Data Storage Component, and used by the Processing Component to create consumer-specific publication parameters, which dictate how the Promotions will be published to the consumer who is the subject of the profile. In another embodiment, the consumer's computer, phone, or tablet is configured to send the consumer's location information to the application, where the Network Communication Component receives it, and the Processing Component compares it to geographically limiting publication parameters to decide which Promotions are published to the consumer. An additional embodiment includes in the merchant profile smaller profiles for divisions, branches, managers, and employees, and configures the Processing Component to create those profiles and the Data Storage Component to store them in a persistent storage. Another embodiment configures the Processing Component to authorize the subjects of those smaller profiles to create and publish Promotions that are within the scope of their profiles. Finally, an embodiment configures the Network Communication Component to publish non-redeemable Promotions, to receive a consumer selection of Promotions via the network, to receive an electronic deposit from said the consumer via the network, to transmit a redeemable version of a Promotion in response, and to receive information from the merchant indicating redemption. The Processing Component is configured to process the electronic deposit and to process a refund of the same upon redemption.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a flow chart illustrating one possible embodiment of the disclosed method.

FIG. 2 is a schematic diagram of a computer or similar electronic device, of the kind that will perform the claimed method and comprise the claimed system.

FIG. 3 is a schematic diagram of the claimed system as assembled over a typical network using web development techniques.

FIG. 4 is a flow chart illustrating several variations of the disclosed method.

### DETAILED DESCRIPTION OF SPECIFIC EMBODIMENTS

The instant invention is a network-connected platform that aids merchants in self-directed publication of Promotions to consumers through the medium web pages or other network distribution protocols, or mobile applications. This invention uses networks of computers and similar devices to disseminate Promotions nearly instantaneously, and allows fine enough control of Promotion creation and publication to match the often rapidly-shifting needs of industries that serve consumers. Automation and the ability to delegate management of the Promotions to any level within a merchant's hierarchy allows the merchant to deploy Promotions quickly and flexibly without wasting upper-level management time, and the ability to create consumer accounts allows market demand to flow to the best available Promotions.

Definitions. As used in this description and the accompanying claims, the following terms shall have the meanings indicated, unless the context otherwise requires.

A “merchant” is any business that sells products or services directly to consumers. Examples of merchants include without limitation retail stores of all kinds, beauty salons, restaurants, bars, gymnasiums, taxi companies, and travel agencies.

“Promotions” are offers to consumers that provide some incentive, such as a discount, to purchase a product or service. Promotions include without limitation coupons, vouchers, discounts, savings Promotions, cash-back offers, and value-add cards. A Promotion is “redeemable” if the consumer can collect on the offer and enjoy the incentive in connection with tender of the Promotion in some form to a merchant. A Promotion is non-redeemable if presenting it to a merchant alone is not sufficient to obtain the incentive it offers. A Promotion can also be seen as collection of data, which could be printed on paper or stored as a data structure in a computer system, and which includes such information as to which products or services the Promotion pertains, which merchant is offering the Promotion, what category and quantity of incentive is offered, where the incentive is available, the duration or expiration date of the Promotion, and any restrictions on its use.

A “promoter” is an entity operating a platform for creation and distribution of Promotions, such as the claimed invention.

“Merchant profile data” is data concerning a merchant, including without limitation the number and locations of branches, the identities of products, brands, and services sold by the merchant, identities of employees, hours of operation of any branches or locations, and pricing information.

A “merchant profile” is a profile created on a computer system containing merchant profile data.

“Consumer profile data” is information that identifies a consumer, aids in directing Promotions to the consumer, and conveys the consumer's preferences with regard to Promotions. Examples of consumer profile data include without limitation the consumer's name, contact information, preferred products and services, preferred merchants, preferred local branches of merchants, price ranges for preferred products and services, categories of preferred Promotions, and other details concerning actual or desired shopping habits.

A “consumer profile” is a profile created on a computer system containing consumer profile data.

A “sub-unit” is any portion of a merchant and its employees, including regional divisions, organizational divisions, branches, locations, individual stores, managers and executives of any level, and employees.

A “sub-unit profile” is a merchant profile containing only data pertaining to the sub-unit that is the subject of the profile, including without limitation the identity, location, and responsibilities of the sub-unit, the products, brands, or services the sub-unit offers or sells, and the portion of the merchant profile that is visible to the sub-unit or may be changed by the sub-unit.

An “electronic device” is defined herein as including personal computers, laptops, tablets, smart phones, and any other electronic device capable of supporting an application as claimed herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

An electronic device's “manual data entry means” is the set of all data entry devices coupled to the electronic device that permit the user to enter data into the electronic device using manual manipulation. Manual entry means include without limitation keyboards, keypads, touchscreens, track-pads, computer mouses, buttons, and other similar components.

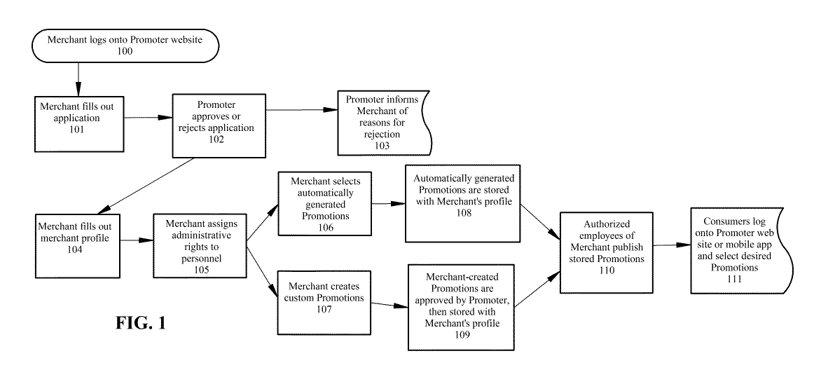

FIG. 1 illustrates one possible embodiment of the claimed method from a merchant's perspective. A merchant interested in offering Promotions to increase business or market share navigates to the promoter's website 100. The merchant fills out a registration application 101, entering enough enrollment data for the promoter to be able to assess the merchant's application. An executive or representative of the promoter decides whether or not to approve the merchant's application 102. This decision is a matter of assessing the economic value to the entity managing the server of a relationship with the merchant, based on such factors as the merchant's credit information, reputation, legal situation, and capitalization. For instance, the promoter managing the server could decide that a given merchant's notoriety or legal difficulties represent too great a risk of negative publicity for the promoter. In any case, if the promoter's representative decides not to approve the merchant application, the merchant is informed 103. Assuming the application is approved, the merchant proceeds to enter more enrollment data 104, which the system assembles into a profile, saved on a persistent storage medium. The merchant edits the profile to give selected employees the right to publish Promotions 105. The merchant then selects automatically generated Promotions 106 which are saved 108 to a persistent storage. The merchant also creates new Promotions 107 of its own design, which are submitted for approval to the promoter 109, and then saved to the persistent storage as well. The employees the merchant authorized to publish Promotions now publish them 110 as needed. Consumers can view and select Promotions on a website or mobile application provided by the promoter 111, and redeem selected Promotions at the merchant's applicable locations.

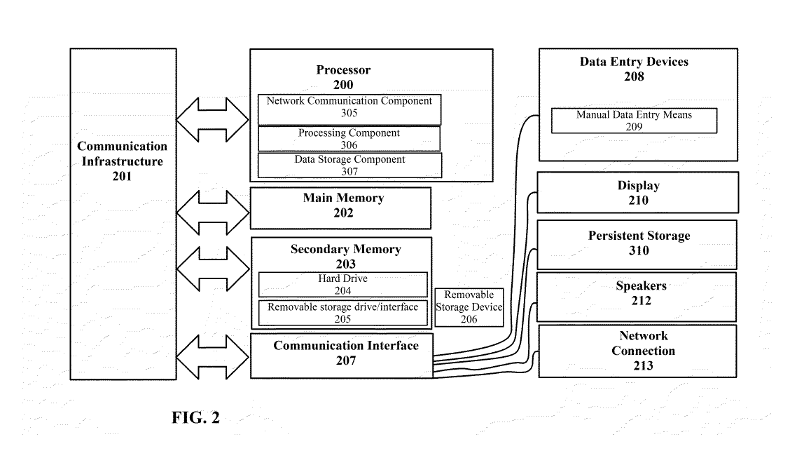

The system and method disclosed herein will be better understood in light of the following observations concerning the electronic devices that support the disclosed application, and concerning the nature of applications in general. An exemplary electronic device is illustrated by FIG. 2. The processor 200 may be a special purpose or a general purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, an radio frequency link or other communications channels. The communications interface in the system embodiments discussed herein facilitates the coupling of the electronic device with data entry devices 208, which can include such manual entry means 209 as keyboards, touchscreens, mouses, and trackpads, the device's display 210, a persistent storage 310, speakers 212, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

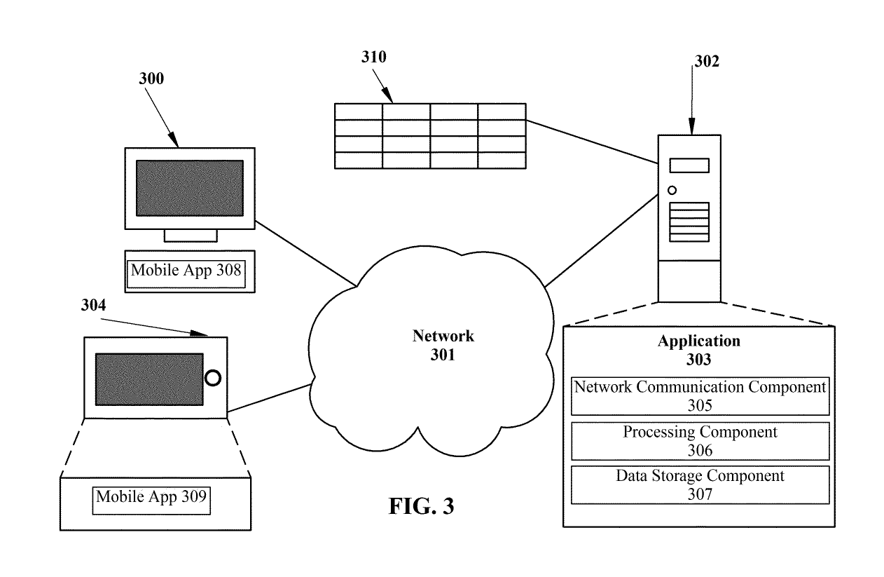

Persons of ordinary skill in the art will recognize a application as a particular kind of computer program system designed to function across a network, such as the Internet. A schematic illustration of a application platform is provided in FIG. 3. Application platforms typically include at least one client device 300, which is an electronic device as described above. The client device 300 connects via some form of network connection to a network 301, such as the Internet. Also connected to the network 301 is at least one server device 302, which is also an electronic device as described above. Of course, practitioners of ordinary skill in the relevant art will recognize that a application can, and typically does, run on several server devices 302 and a vast and continuously changing population of client devices 300. Computer programs on both the client device 300 and the server device 302 configure both devices to perform the functions required of the application. Applications can be designed so that the bulk of their processing tasks are accomplished by the server device 302, as configured to perform those tasks by its application program, or alternatively by the client device 300. However, the application must inherently involve some programming on each device.

Many electronic devices, as defined herein, come equipped with a specialized program known as a web browser, that enables them to act as a client device 300 at least for the purposes of receiving and displaying data output by the server device 302 without any additional programming. Web browsers can also act as a platform to run so much of a application as is being performed by the client device 300, and it is a common practice to write the portion of a application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a application client 300. Such separately installed programs on client devices are referred to herein as “mobile applications.” Thus, as a general matter, applications require some computer program configuration of both the client device 300 (or devices) and the server device 302 (or devices). The computer program that comprises the application component 215 on either electronic device's system FIG. 2 configures that device's processor 200 to perform the portion of the overall application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a application as used herein uses the kind of hypertext markup language protocol popularized by the World Wide Web, practitioners of ordinary skill in the art will be aware of other network communication protocols, such as File Transfer Protocol, that also support applications as defined herein.

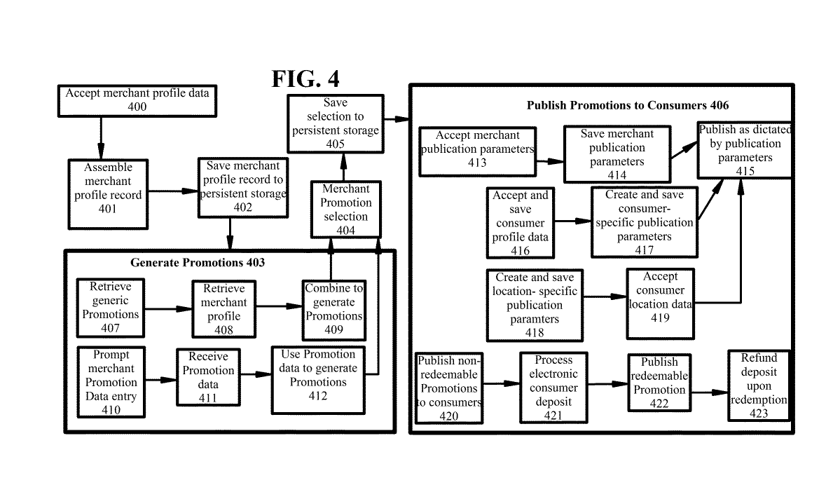

According to the simplest embodiment of the claimed method FIG. 4, the server receives merchant profile data 400 from a merchant. The merchant profile data can include a wide range of data depending on the particular implementation. At the simplest extreme the merchant profile data could be nothing more than the minimum necessary to identify the merchant. However, the profile data could also include a list of merchant locations or branches, a list of the managers or employees at each branch, lists of products, brands, or manufacturers the merchant carries, pricing information, and schedule information, among other things. The server then assembles the profile data into a merchant profile 401, and saves it to a persistent storage 402. The next step in the method is the generation of Promotions 403 that the merchant could use to sell products. The server generates Promotions by collecting data concerning the merchant, the merchant's products, and possible forms of Promotions, assembling that data into data structures or analogous collections of data containing such elements as the kind of Promotion (e.g. a sale), the degree of the Promotion (e.g. 20% of typical retail price), the duration of the Promotion, and the products and locations to which it pertains. The merchant selects Promotions from the set of generated Promotions 404 and the server saves the merchant's selections to a persistent storage 405. Finally, the server publishes the selected Promotions over a network such as the internet, for consumers to see 406.

The corresponding system embodiment FIG. 3 involves a server 302 connected to a network 301, such as the internet, to which is also connected at least one merchant client terminal 300 and at least one consumer client terminal 304. The server 302, merchant client terminal 300, and consumer client terminal 304 are all electronic devices as defined and discussed above. The server 302 is programmed to run an application 303, which includes a Network Communication Component 305, a Processing Component 306, and a Data Storage Component 307. The merchant client terminal 300 and consumer client terminal 304 are each configured to run a web client, such as a web browser, that will display data they receive from the server 302 via the network 301, run client-side programming that they receive by the same means, and transmit data entered by consumers and merchants, via the terminals' manual entry data means, over the network 301 to the server 302. On the server 302, the Network Communication Component 305 is designed to send and receive data. In particular, the Network Communication Component 305 receives merchant profile data and Promotion selections via the network 301 from the merchant client terminal 300, and transmits selected Promotions to the consumer client terminal 304. The Processing Component 306 performs processing tasks with data, including assembling merchant profiles, and generating Promotions. The Processing Component 306 accomplishes the latter task by combining data from either of the other Components 305, 307, and filling in the necessary data to complete a Promotion, such as the products, product families or brands subject to the Promotion, the duration of the Promotion, and the percentage or amount of savings or other advantages the Promotion provides. The Data Storage Component 307 saves and retrieves data for the application to persistent storage 310 available to the server 302, including merchant profiles and Promotion selections. As persons skilled in the art will know, persistent storage 310 may be an unstructured or structured collection of data, such as a database that can divide the data stored into fields representing useful categories of data. As a result, a stored data record can be quickly retrieved using any known portion of the data that has been stored in that record by searching within that known datum's category within the persistent storage. Persistent storage can be created in any digital memory. Likewise, any system embodiment of this invention could involve one or more electronic devices as portrayed in FIG. 2. In particular, the persistent storage 310 could be installed on the same server device as the application, or maintained on a separate electronic device acting as a data server, while the application is run on other electronic devices acting as the server. Furthermore, it is worth noting that the Processing Component 306, Data Storage Component 307, and Network Communication Component 305 need not be separate entities or modules within a particular program as implemented. The purpose of their status as elements in the system described herein is to establish that the processor 200 must be configured to perform their functions as set forth, but not to dictate the architecture of a particular implementation.

In another embodiment of the method FIG. 4, the generation of Promotions 403 is accomplished by an automated process in the server. To accomplish this, a set of generic Promotions are maintained in persistent storage coupled to the server. These generic Promotions have pre-selected elements of common Promotions. For example, a generic Promotion in the persistent storage might contain a 20% discount for a two-week duration, but not specify the product or family of products affected, or which merchant is offering the Promotion. The server retrieves the generic Promotions 407, and retrieves the merchant profile data 408. Then, the two data sets are combined to produce merchant-specific Promotions 409. To continue the above example, if the merchant profile contains a list of product families the merchant carries, the server can create a set of Promotions, each of which offers a 20% discount for two weeks on one of the product families. An additional Promotion could be created offering a 20% discount on all products, which could be created even if the merchant did not provide product information in its profile. At minimum, each merchant-specific Promotion 409 could contain the identification of the merchant, which should exist in every profile; if branch-location identifications are provided, merchant-specific Promotions can be generated specifying each particular branch as well. As noted above, the merchant will have the opportunity to select 404 desired Promotions from among the merchant-specific Promotions once they have been generated 409.

The corresponding system embodiment involves configuring the Data Storage Component 307 to retrieve generic Promotions from a persistent storage coupled to the server, and configuring the Processing Component 306 to combine those generic Promotions with merchant profile data, which the Data Storage Component 307 is already configured to retrieve. To produce the merchant-specific Promotions, the Processing Component could traverse the data set of all generic Promotions, adding at minimum the merchant's identifying data to each generic Promotion. The data set of all generic Promotions could be gathered in a data structure such as a linked list, tree, array, or one of many other such structures known to persons of ordinary skill in the art. It is also possible to replicate the behavior of such data structures without instantiating them in the source code per se, or even to avoid their function altogether by repeatedly querying the persistent storage for single generic Promotion records. It is also possible to begin the process of merchant customizing by filtering the generic Promotions by fields, for instance in the persistent storage query itself, to eliminate processing those that obviously do not apply for a given merchant's business model as described in the merchant profile. For each generic Promotion, the Processing Component 306 could be further configured to traverse data sets of merchant product families or products, and merchant branches, locations, and other divisions, adding data relating to each to the merchant-specific Promotions. This is only one possible approach to implementing this embodiment; persons of ordinary skill in the art will be aware of other algorithms that could accomplish similar results, including performing all possible combinations in the persistent storage query itself. Finally, the Network Communication Component 305 is already configured to send these automatically generated Promotions to the merchant for selection and approval.

Another method embodiment FIG. 4 involves permitting the merchant to create its own Promotions for the Promotion generation step 403. The Promotion generation portion of the method in this case involves prompting the merchant to enter its own Promotion data 410. This might involve guiding the entry of specific fields for the merchant, or running a series of steps in which the merchant is prompted to enter different categories of data; alternatively, it could simply involve allowing the merchant to enter text with whatever contents the merchant wished, in any format the merchant desired. Upon receiving 411 the Promotion data, the system combines it to create one or more Promotions 412, which could be directed entirely by the merchant's instructions, or could be partially automated to fit the Promotions into some standard form, depending upon the implementation. As a fail-safe, the merchant can still accept or reject the final product 404. The equivalent system embodiment FIG. 3 would configure the Network Communication Component 305 to prompt the manager to enter Promotion data by sending data over the network which the merchant client terminal's 300 web client would render as graphical, image, or textual instructions to enter Promotion data, for example by following standard procedures to render hypertext markup language. The Network Communication Component 305 is further configured to receive the merchant's Promotion data over the network, and the Processing Component 306 is configured to arrange the Promotion data to create Promotions, which may be presented to the merchant for approval. Finally, the merchant client terminal 300 must be configured to display the prompts and to enter the Promotion data; note that where the merchant client terminal 300 is using a web browser or similar product as its client software, no additional configuration will be needed to accomplish this part of the embodiment. If necessary, the promoter can configure the system to require promoter approval prior to system storage of the merchant's custom created Promotions, to avoid illegal or otherwise problematic Promotions being published.

The convenience of the consumer experience of this invention may be greatly enhanced by the provision of a mobile application on the consumer's phone, tablet, or personal computer. The use of a mobile application would permit the consumers, for example, to download desired Promotions and save them in local memory so that they are available even in the absence of network connections. A mobile application could also simplify and streamline the consumer experience due to its dedicated use as a special-purpose web client. The implementation of a mobile application would involve the creation of a platform-specific user-interface and web client program, the production of which is a matter of common knowledge to persons of ordinary skill in the art. The system embodiment FIG. 3 involves configuring the consumer client terminal 304 and the merchant client terminal 300 to perform the function of a mobile application 309, 308.

Automation of the publication process can make it far more convenient and reliable for merchants. To that end, a method embodiment FIG. 4 allows the merchant to set parameters within which the publication will occur 413. For example, the merchant could dictate that a particular Promotion or set of Promotions will be published for a particular two-week period, or in a particular location. The merchant could also specify some recurring sale, for example, an annual sale at a car dealership in February. The merchant could also restrict the sale to a particular geographic area or branch. Whatever parameters the merchant enters into the system are saved 414 in a persistent storage. The step of publication 406 for a particular Promotion to which the parameters correspond will then happen only as allowed by the parameters 415. Thus, for instance, the system will not send out a Promotion or make it available on the website before or after the date range the merchant has specified for that Promotion's publication. The equivalent system embodiment FIG. 3 requires configuring the Network Communication Component 305 to receive Publication parameters from the merchant client terminal via the network, configuring the Data Storage Component 307 to save those parameters to the persistent storage, and configuring the Processing Component 306 to test for parameters prior to sending Promotions for publication, rejecting Promotions outside the applicable parameters. For an example of the last task, one implementation would be to store each parameter as a value, loop through all the parameters pertaining to a certain merchant, and compare each parameter value to a data field in each Promotion or to the date and time in the case of purely temporal parameters.

Another facet of the claimed invention that should prove very useful to merchants who wish to advertise effectively allows the Promotions to be targeted to specific consumers. This is accomplished FIG. 4 by allowing individual consumers to register by entering their own consumer profile data 416, which is saved to a persistent storage. This in turn can be used to create consumer-specific publication parameters 417, causing the Promotions to be published to a particular consumer more selectively 415. The simplest way to implement this system would be to ask the consumer to share preferences in his or her profile data during registration (and to modify them later as desired), and to have the consumer identify him or herself when using the system, either by logging onto the website, or by having a mobile application share the consumer's identity with the application when in use. The system can be designed to accomplish the same result by configuring the consumer client terminal 304 and merchant client terminal 300 to accept consumer profile information, configuring the Network Communication Component 305 to prompt and receive consumer profile information, configuring the Processing Component 306 to create publication parameters and apply them prior to publication, and configuring the Data Storage Component 307 to store consumer profile data and consumer-specific publication parameters. The merchant client terminal 300 should be able to enter consumer profile information because it will enable merchants to offer consumers future savings opportunities at the point of sale, and register the consumers to provide them with that savings, given permission.

Another way to target Promotions effectively is to limit their publication according to geographical parameters FIG. 4. Thus, a publication parameter can be created using geographical limitations 418 such as restriction of its publication to residents of a particular metropolitan area, or to people who are physically in that metropolitan area at the moment of publication. This parameter can be compared to consumers' location information 419, for example by looking at the municipality of the consumer's address according to consumer profile data (in which case the step of receiving the consumer's location data may be accomplished one time only during profile creation), or by receiving from the consumer client terminal via the network the current location of the consumer as generated by a navigational system such as the Global Positioning System. In either case, the consumer's browser, mobile application, or other consumer client terminal program will only be sent Promotions whose geographical limitations match the consumer's address or current location 415. The same effect may be achieved in the system FIG. 3 by configuring the consumer client terminal 304 to transmit location data over the network to the Network Communication Component 305. The Processing Component 306 is configured to compare consumer location data to publication parameters containing geographical limitations, and to allow the publication of Promotions only if the consumer is within the geographical limitations dictated by the parameters. As before, note that the location data can pertain to the consumer's physical location at the time of publication or to the consumer's address or similar geographical information.

Particularly where the merchant is a large organization, such as a store chain, a great deal of the work necessary to the merchant's function will be completed more efficiently if the merchant can delegate it to divisions, branches, store locations, and particular employees. These sub-units of the merchant could be permitted to view the entire merchant profile, but some merchants might prefer to limit their access to and ability to change the profile. For that purposes, the merchant can include profile data for each sub-unit in the merchant profile data submitted to the system. The method FIG. 4 may be enhanced to include the creation of profiles for each such sub-unit using that data during the creation of the merchant profile 401. The sub-unit profiles would be a part of the overall merchant profile. Each sub-unit would have the ability to access its own sub-unit profile, and view only what the sub-unit profile permitted it to view. A typical sub-unit profile might describe a store manager, include his or her name, employee identification, and the store number at which he or her is a manager, and allow that store manager to view as much of the merchant profile as the merchant deems relevant to his or her duties as a store manager. The ability to change or submit profile data 400 could be similarly restricted. The corresponding system embodiment involves configuring the Processing Component 306 to create sub-unit profiles that are part of the merchant profile, and configuring the Data Storage Component 307 to store those sub-unit profiles.

One particularly useful feature of the instant invention FIG. 4 involves authorizing sub-units to create or publish particular Promotions 406 in their own right. This would allow a store manager, for example, to react to an overstocked product by offering it to consumers at a discount. By allowing the store manager to make this decision on his or her own, the merchant permits the sale to be created more quickly than would be possible if the store manager had to call the merchant's central headquarters for approval. The quick turnaround would be especially useful where the stock in question was perishable. To accomplish this, one embodiment of the method involves creating sub-unit profiles along with the merchant profile 401, which authorize the sub-unit to publish or create certain Promotions. The corresponding system embodiment FIG. 3 requires configuring the Processing Component 305 to include in the sub-unit profiles the authorization to create and publish certain Promotions, for example by describing a data element in the sub-unit profile, and excluding all Promotions for publication that do not contain that data element. For instance, a store manager's store identification could be required on all Promotions that the manager publishes, and the manager likewise would not be able to enter a different store location in a Promotion that the manager created.

An alternative way for merchants to exert control over the Promotions they advertise is described in final embodiment of the method FIG. 4. Rather than simply publishing redeemable Promotions directly to consumers, this embodiment involves publishing a list of Promotions that are not redeemable 420 to consumers. To obtain a redeemable Promotion, a consumer must log onto the website and electronically pay a deposit 421. Persons of ordinary skill in the relevant art will be aware that electronic payments are a common element of internet commerce, and that a number of ways to perform them are available, including using third-party payment processing companies and processing credit-card payments directly with banks Once the deposit has been paid, the system sends a redeemable Promotion to the consumer 422. The consumer can bring this Promotion to any merchant location or store for redemption. Upon redemption, the consumer's deposit is refunded 423, completing the transaction. To implement this in the system, the Network Communication Component 305 must be configured to transmit to a consumer client terminal 304 a list of non-redeemable Promotions via the network, to receive an electronic deposit from the consumer, and to transmit in response a redeemable Promotion. The Network Communication Component 305 must also be configured to receive from a merchant client terminal 300 data indicating that the Promotion has been redeemed by the consumer. The Processing Component 306 must likewise be configured to process the electronic deposit, and to process the refund of that deposit upon receiving data indicating that the Promotion has been redeemed.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method of controlling distribution of Promotions for a merchant, performed using a application hosted on a server or servers connected to a network, comprising:
accepting merchant profile data from said merchant on said server(s) via said network;
assembling said merchant profile data into a merchant profile;
saving said merchant profile to a persistent storage available to the server(s);
generating one or more Promotions on said server(s);
accepting merchant selections of said Promotions on said server(s);
saving said selected Promotions to persistent storage available to the server(s); and
publishing said selected Promotions to consumers.

2. A method according to claim 1, wherein the generation of Promotions comprises:
maintaining in a persistent storage a set of generic Promotion options;
retrieving said generic Promotion options from said persistent storage; and
combining said generic Promotion options with merchant enrollment and profile data to produce merchant-specific Promotions.

3. A method according to claim 1, wherein the generation of Promotions comprises:
prompting the merchant to enter Promotion data;
accepting said Promotion data entered by said merchant; and
combining said Promotion data to create new Promotions.

4. A method according to claim 1, further comprising:
allowing said merchant to create publication parameters for said Promotions; and
publishing said Promotions according to said publication parameters.

5. A method according to claim 4, wherein said publication step comprises:
registering new consumers by accepting consumer profile data and saving it in a persistent storage coupled to said server;
setting consumer-specific publication parameters; and
publishing Promotions to particular consumers as dictated by said consumer-specific parameters.

6. A method according to claim 4, wherein said publication parameters include geographic limitations, and further comprising acquiring consumers' location data from consumer devices and comparing said location data to said publication parameters to determine whether said consumer is located within said geographical limitations.

7. A method according to claim 1, wherein said merchant profile contains sub-unit profiles.

8. A method according to claim 7, further comprising authorizing sub-units to create or publish Promotions within limits dictated by their sub-unit profiles.

9. A method according to claim 1, wherein publication of Promotions to consumers comprises:
publishing a list of non-redeemable Promotion selections;
accepting a consumer selection of a Promotion;
accepting an electronic deposit from said consumer;
sending said consumer the selected Promotion in a form redeemable at a merchant location; and
refunding said deposit to said consumer upon redemption of said Promotion.

10. A system for controlling distribution of Promotions for a merchant, comprising:
at least one server connected to a network, the server having a processor and a memory, said processor operable to perform functions of a application comprising:
a Network Communication Component, configured to send and receive data and send client-side programming over said network, including receiving merchant profile data and Promotion selections from said merchant via said network and transmitting data including Promotions via said network;
a Processing Component configured to process data, including assembling said merchant profile data into a merchant profile and generating one or more Promotions on said server;
a Data Storage Component configured to save data to a persistent storage or persistent storages coupled to said server, including merchant profiles, and selected Promotions; and
at least one merchant client terminal connected to said network, said terminal having a processor and a memory, said processor configured to accept data including merchant profile data and Promotion Selections from said merchant via said merchant client terminal's manual entry data means, to transmit data to said server via said network, and to receive data including Promotions from said server via said network, to display said data via its display means, and to receive and execute client-side programming from said server via said network; and
at least one consumer client terminal connected to said network, said terminal having a processor and a memory, said processor configured to send and receive data, including reception of Promotions from said server via said network, to receive and execute client-side programming from said server via said network, and to display data including said Promotions using its display means.

11. A system according to claim 10 wherein:
said Data Storage Component is further configured to retrieve a set of generic Promotions from a persistent storage coupled to said server; and
said Processing Component is configured to combine said generic Promotions with merchant enrollment and profile data to produce merchant-specific Promotions.

12. A system according to claim 10 wherein said merchant client terminal is further configured to accept Promotion data entered by said merchant, and to transmit said Promotion data to said server via said network; and wherein said Network Communication Component is further configured to transmit prompts to the merchant instructing it to enter Promotion data and to receive said Promotion data via said network; and wherein said Processing Component is further configured to arrange said Promotion data to create new Promotions.

13. A system according to claim 10 where said merchant client terminal and consumer client terminal are further configured to perform functions comprising mobile applications.

14. A system according to claim 10 where said merchant client terminal is further configured to accept publication parameter data entered by said merchant via said merchant client terminal's manual data entry means and to transmit said publication parameter data to said server via said network; and where said Network Communication Component is configured to receive said publication parameter data from said network, and said Processing Component is configured to permit transmission of said Promotions which correspond to said publication parameters only as dictated by said publication parameters.

15. A system according to claim 14, wherein said consumer client terminal or merchant client terminal is configured to accept consumer profile data, and wherein:
said Network Communication Component is configured to receive consumer profile data from said merchant client terminal or consumer client terminal;
said Processing Component is configured to generate consumer-specific publication parameters using said consumer profile data and to permit transmission of Promotions as dictated by said consumer-specific publication parameters; and
said Data Storage Component is configured to save consumer profile data and consumer-specific publication parameters in a persistent storage coupled to said server;

16. A system according to claim 14, wherein said consumer client terminal is further configured to transmit a consumer's location data to said server via said network, and wherein said publication parameters include geographical limitations, and wherein said Network Communication Component is configured receive said location data via said network, and wherein said Processing Component is configured to compare said location data to said publication parameters to determine whether said consumer is located within said geographical limitations, and to permit transmission of Promotions to which said publication parameters pertain to said consumer client terminal only if said consumer is located within the geographical limitations of said publication parameters.

17. A system according to claim 10, wherein said merchant profile data contains sub-unit profile data, and wherein said Processing Component is further configured to create sub-unit profiles as components of said merchant profiles, and wherein said Data Storage Component is further configured to store sub-unit profiles as components of said merchant profiles.

18. A system according to claim 17, wherein said Processing Component is further configured to authorize sub-units to create and select for publication Promotions within limits dictated by their sub-unit profiles.

19. A system according to claim 10, wherein:
said Network Communication Component is configured to transmit non-redeemable Promotion selections, to receive a consumer selection of a Promotion from a consumer client terminal via said network, to receive an electronic deposit from said consumer client terminal via said network, to transmit to said consumer client terminal the selected Promotion in a form redeemable at a merchant location, and to receive from said merchant client terminal data indicating that said redeemable Promotion has been redeemed; and
said Processing component is configured to process said electronic deposit and to process a refund of said consumer's electronic deposit.
